(19) United States
(12) Patent Application Publication
(10) Pub. No.: US 2018/0029884 A1
(43) Pub. Date: Feb. 1, 2018

(54) METHODS FOR HYDROGENATION OF CARBON DIOXIDE TO SYNGAS

(71) Applicant: SABIC Global Technologies B.V., Bergen op Zoom (NL)

(72) Inventors: Aghaddin MAMEDOV, Sugar Land, TX (US); Xiankuan ZHANG, Sugar Land, TX (US); Clark REA, Sugar Land, TX (US)

(21) Appl. No.: 15/551,827

(22) PCT Filed: Feb. 5, 2016
(86) PCT No.: PCT/US16/16810

§ 371 Date: Aug. 17, 2017

Related U.S. Application Data
(60) Provisional application No. 62/119,593, filed on Feb. 23, 2015.

(51) Int. Cl. C01B 3/02; B01J 19/02

(52) U.S. Cl. CPC C01B 3/02; B01J 19/02; B01J 2219/029

(57) ABSTRACT

The present disclosure provides methods for the hydrogenation of carbon dioxide. In one non-limiting exemplary embodiment, the presently disclosed subject matter provides a method for the hydrogenation of carbon dioxide to form syngas that includes contacting a feedstream that contains hydrogen and carbon dioxide with a catalyst at a temperature of about 650° C. in an Inconel alloy reactor to produce a syngas mixture that includes hydrogen and carbon monoxide.

### CROSS-REFERENCE TO RELATED APPLICATIONS

This application claims the benefit of priority of U.S. Provisional Patent Application No. 62/119,593, filed Feb. 23, 2015, which is hereby incorporated by reference in its entirety.

### FIELD

The present disclosure relates to methods for the hydrogenation of carbon dioxide to form syngas.

### BACKGROUND

Increased awareness of the environmental impact of carbon dioxide emissions has led to interest in research and efforts to convert carbon dioxide into useful chemical materials. Techniques for converting carbon dioxide into syngas, also known as synthesis gas, have been applied in chemical factories and oil refineries where a relatively large amount of carbon dioxide is generated. Syngas, which includes hydrogen and carbon monoxide and can further contain other gas components, e.g., carbon dioxide (CO₂), water (H₂O), methane (CH₄) and/or nitrogen (N₂), can be used as feedstock for the production of higher hydrocarbons, such as fuels, or to produce chemical reaction intermediates, such as methanol.

Certain methods for generating syngas from carbon dioxide are known in the art. U.S. Pat. No. 2,577,563 discloses a method for the hydrogenation of carbon oxides to produce hydrocarbons, which includes the use of a catalyst oxidation chamber fabricated with Inconel having a composition of about 80% nickel, 15% chromium and 5% iron. European Patent No. EP2594527 discloses a method for the generation of syngas from the tail gas of Fischer-Tropsh reactions. The method includes the selective hydrogenation of the olefins in the tail gas followed by the reforming of the hydrogenated tail gas to produce syngas. U.S. Patent Application No. 2009/0313886 discloses a method for the generation of liquid fuel that includes performing a reverse water gas shift (RWGS) reaction in an Inconel 600-based reactor to generate synthesis gas through the use of solar energy followed by the conversion of the syngas into liquid fuel.

U.S. Patent Application No. 2011/0291425 discloses a method that includes the use of a plasma melter and a fuel material to produce syngas followed by the extraction and transfer of carbon dioxide from the syngas to a bioreactor for the growth of algae. U.S. Pat. No. 8,551,434 discloses a method for the generation of syngas from carbon dioxide and hydrogen at a temperature of 700° C. or higher. U.S. Pat. No. 8,288,446 discloses a method for the generation of syngas from carbon dioxide and hydrogen in the presence of a catalyst.

Reactors that can be used in the hydrogenation of carbon dioxide to form syngas are typically manufactured from material containing nickel, iron and/or chromium. The contact of nickel with the reactants of the hydrogenation reaction can result in methanation reactions. Methanation reactions, which produce methane (CH₄) and water from hydrogen and a carbon source, such as carbon dioxide and carbon monoxide, may not be desired during syngas production. The formation of methane can reduce the amount of syngas that is generated and can result in coke formation. Coke and coke fragments can coat and foul both the catalysts and reactor components, shortening catalyst life and damaging reactor components and/or require frequent cleaning and maintenance. To prevent the formation of methane and/or coke within the reactor, the interior surfaces of the reactor can be subjected to a passivation process to prevent the interaction of the metal components of the reactor, e.g., nickel, with the reactants of the hydrogenation reaction. However, such processes can be labor intensive and expensive.

Therefore, there remains a need in the art for more efficient methods for producing syngas that minimize the formation of methane and coke within the reactor.

### SUMMARY

The presently disclosed subject matter provides methods for the hydrogenation of carbon dioxide to syngas.

In certain embodiments, a method for producing syngas can include contacting a feedstream that includes hydrogen and carbon dioxide with a catalyst at a temperature of about 650° C. in a reactor to produce a syngas mixture containing hydrogen and carbon monoxide. In certain embodiments, the reactor is made from an Inconel alloy. In certain embodiments, coke or methane formation is reduced during long-term operation of the Inconel alloy-based reactor to produce a syngas according to the methods of the disclosed subject matter as compared to a reactor that does not include an Inconel alloy. In certain embodiments, the Inconel alloy is Inconel-601. In certain embodiments, the Inconel alloy includes from about 58% to about 63% nickel and from about 21% to about 25% chromium. In certain embodiments, the long-term operation of the reactor is a time period of about 6 months or more.

In certain embodiments, a method for producing syngas includes introducing a feedstream containing hydrogen and carbon dioxide into a reactor, where the reactor is made from an Inconel alloy. The method can further include contacting the feedstream with a catalyst at a temperature lower than about 700° C. to generate a syngas mixture that includes carbon monoxide and hydrogen. In certain embodiments, the method includes removing a substantial portion of the syngas mixture from the reactor. In certain embodiments, coke or methane formation is reduced and/or does not increase during long-term operation of the Inconel alloy-based reactor to produce a syngas according to the methods of the disclosed subject matter as compared to a reactor that does not include an Inconel alloy. In certain embodiments, the Inconel alloy is Inconel-601.

The presently disclosed subject matter provides a method for producing synthesis gas that includes contacting a gaseous hydrocarbon feedstream containing carbon dioxide and hydrogen with a catalyst in a nickel-based metal reactor at a temperature of about 650° C. In certain embodiments, the nickel-based metal of the reactor includes from about 58% to about 63% nickel and from about 21% to about 25% chromium. In certain embodiments, the nickel-based metal of the reactor is an Inconel alloy. For example, and not by way of limitation, the Inconel alloy can be Inconel-601.

In certain embodiments, a method for producing syngas includes contacting a gaseous hydrocarbon feedstream containing carbon dioxide and hydrogen with a catalyst in an Inconel-601 alloy reactor at a temperature of about 650° C. to about 750° C., where coke or methane formation is reduced and/or does not increase during long-term operation of the reactor when compared to a reactor that is not fabricated from Inconel-601. In certain embodiments, the temperature at which the gaseous hydrocarbon feedstream contacts the catalyst can be from about 650° C. to about 700° C.

### BRIEF DESCRIPTION OF THE DRAWINGS

FIG. 1 depicts a method for producing syngas by hydrogenation of carbon dioxide according to one exemplary embodiment of the disclosed subject matter.

FIG. 2 shows the hydrogenation of carbon dioxide in an Inconel reactor under isothermal conditions in accordance with one exemplary embodiment of the disclosed subject matter.

FIG. 3 shows the hydrogenation of carbon dioxide in an example 316 steel metal reactor.

### DETAILED DESCRIPTION

The presently disclosed subject matter provides methods for the hydrogenation of carbon dioxide to form syngas. In certain embodiments, the presently disclosed subject matter provides a method for the hydrogenation of carbon dioxide that reduces and/or minimizes the formation of methane and coke on the interior surfaces of the reactor and/or on the catalyst during the generation of syngas.

Carbon dioxide (CO₂) is selectively converted into carbon monoxide by a reverse water gas shift (RWGS) reaction in the presence of a catalyst under certain reaction conditions. The resulting product of this CO₂ hydrogenation process is a gas mixture called syngas. Syngas formed by the RWGS reaction includes carbon monoxide and hydrogen, and can further contain water and non-converted carbon dioxide. The RWGS reaction can be represented by the following equation:

CO₂+nH₂⇄CO+(n−1)H₂+H₂O [Reaction Formula 1]

In Reaction Formula 1, n can vary, e.g., from n=1 to n=5, to result in a syngas composition, e.g., expressed as its H₂/CO ratio or as the stoichiometric ratio denoted by the formula (H₂−CO₂)/(CO₂+CO), that can consequently vary within wide limits. In certain embodiments, the syngas produced by the methods of the disclosed subject matter has a stoichiometric ratio of about 0.5 to about 3.2.

The term “about” or “approximately” means within an acceptable error range for the particular value as determined by one of ordinary skill in the art, which will depend in part on how the value is measured or determined, i.e., the limitations of the measurement system. For example, “about” can mean a range of up to 20%, up to 10%, up to 5% and/or up to 1% of a given value.

Methanation reactions, which can occur concomitantly with the RWGS reaction in the presence of nickel and/or iron, are reactions that produce methane (CH₄) and water from hydrogen and a carbon source, such as carbon dioxide and/or carbon monoxide, as represented by Reaction Formula 2. The formation of methane or other alkanes byproducts is generally not desired during syngas production. Not only does methane production compete with and reduce the amount of syngas produced, the formation of such byproducts also correlates to coke formation in the reactor. Coke and coke fragments can accumulation on both the catalysts and reactor components, resulting in catalyst deactivation and damaging reactor components or requiring increased frequency of cleaning/maintenance and reactor downtime.

CO₂+nH₂⇄CH₄+(n−1)H₂O [Reaction Formula 2]

The presently disclosed subject matter provides methods for generating syngas by the hydrogenation of carbon dioxide that minimizes the amount of methane and coke formation in the reactor. In the disclosed methods, carbon dioxide can be selectively converted into syngas containing carbon monoxide (CO) and hydrogen (H₂) by a RWGS reaction in the presence of a catalyst, as represented by Reaction Formula 1. In certain embodiments, the syngas produced from CO₂ hydrogenation does not contain nitrogen (N₂); whereas, the syngas generated from other reactions, for example, from methane auto thermal steam reforming or from methane auto thermal dry reforming, can contain nitrogen if air is used as an oxidant instead of oxygen.

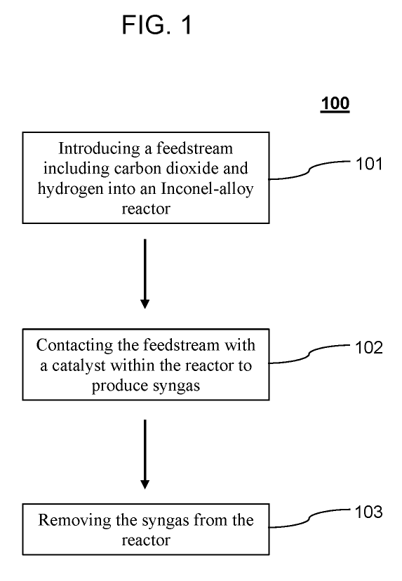

For the purpose of illustration and not limitation, FIG. 1 is a schematic representation of a method according to a non-limiting embodiment of the disclosed subject matter. In certain embodiments, the method 100 includes introducing a feedstream containing hydrogen and carbon dioxide into a reactor 101.

In certain embodiments, the feedstream contains at least about 20% of CO₂ and at least 70% of hydrogen. In certain embodiments, the feedstream can contain equimolar amounts of CO₂ and H₂ (n=1 in Reaction Formula 1), resulting in a syngas composition that primarily includes CO, which can be used as a feedstream for further chemical reactions, e.g., carbonylation reactions. In certain embodiments, the feedstream can contain CO₂ and H₂ in a molar ratio of about 1:2 (n=2 in Reaction Formula 1) or a molar ratio of about 1:3 (n=3 in Reaction Formula 1).

The H₂ in the gaseous feedstream used in the method of the presently disclosed subject matter can originate from various sources, including gaseous streams coming from other chemical processes, e.g., ethane cracking, methanol synthesis or conversion of CH₄ to aromatics. The CO₂ in the gaseous feedstream used in the method of the presently disclosed subject matter can originate from various sources. In certain embodiments, the CO₂ can come from a waste gas stream, e.g., from a plant on the same site, or after recovering CO₂ from a gas stream. Recycling CO₂ as starting material in the methods of the presently disclosed subject matter can contribute to reducing the amount of CO₂ emitted to the atmosphere, e.g., from a chemical production site. The CO₂ used within the feedstream can also, at least partly, originate from the effluent gas or product of the disclosed methods and recycled back to the reactor in the feedstream.

The method 100 can further include contacting the feedstream with a catalyst contained within the reactor to produce syngas 102. Examples of suitable catalysts are provided below. Examples of suitable reactors are provided below. For example, and not by way of limitation, the reactor can be an Inconel-601 reactor.

The feedstream can contact the catalyst at isothermal conditions. For example, and not by way of limitation, the feedstream can contact the catalyst at a temperature of about 650° C. to about 750° C. In certain embodiments, the feedstream can contact the catalyst at a temperature of about 650° C. to about 700° C., e.g., from about 650° C. to about 680° C. In certain embodiments, the feedstream can contact the catalyst at a temperature less than about 700° C.

In certain embodiments, the feedstream can contact the catalyst at a temperature of about 650° C. The contact time for contacting the feedstream with the catalyst can depend on a number of factors, including but not limited to, the temperature, the pressure and the amount of catalyst and reactants. In certain embodiments, contact time for contacting the feedstream with the catalyst can be from about 1 to about 9 seconds.

In certain embodiments, the method includes removing the syngas from the reactor 103. For example, and not by way of limitation, a substantial portion of the syngas produced can be removed from the reactor. The term “substantial portion,” as used herein, can refer to an amount greater than about 50%, greater than about 60%, greater than about 70%, greater than about 80%, greater than about 85%, greater than about 90%, greater than about 95% or greater than about 99% of the syngas product. In certain embodiments, the syngas mixture can be removed from the reactor and fed into a second reactor as a feedstream for performing an additional chemical reaction. Non-limiting examples of such reactions include Fischer-Tropsch reactions, aromatics production, carbonylation of methanol and hydrocarbonylation of olefins.

The reactor for use in the methods of the present disclosure can be any reactor type used for hydrogenation of carbon dioxide known to one of ordinary skill in the art. For example, but not by way of limitation, such reactors include fixed bed reactors, such as multi-tubular fixed bed reactors, and fluidized bed reactors, such as entrained fluidized bed reactors and fixed fluidized bed reactors. The dimensions and structure of the reactor of the presently disclosed subject matter can vary depending on the capacity of the reactor. The capacity of the integrated reactor system can be determined by the reaction rate and the stoichiometric quantities of the reactants.

The reactors for use in the presently disclosed methods can contain nickel-based alloys. For example, and not by way of limitation, the reactor can be manufactured from an Inconel alloy. Alternatively or additionally, the interior surfaces of the reactor can be manufactured from an Inconel alloy, whereas other components can be fabricated from a different type of metal, e.g., steel. In certain embodiments, the Inconel alloy can be Inconel-601. In certain embodiments, the Inconel alloy can be Inconel-600. However, the use of Inconel-600 results in the disclosed methods results in greater coke formation that the use of Inconel-601. Without being bound to a particular theory, this difference in methane formation, is due, at least in part, to the high amount of nickel (Ni) content in the Inconel 600 metal reactor, which is 72%; whereas, the Inconel 601 has a Ni content in the range of about 58% to about 63%. Furthermore, Inconel-600, in comparison to Inconel 601, contains a lower amount of the redox element chromium (Cr). Inconel-601 has a Cr content within the range of about 21 to about 25% while the Inconel tube 600 has a Cr content in the range 14-17%. In certain embodiments, the Inconel alloy for use in the present disclosure includes less than about 70% of nickel. In certain embodiments, the nickel-based and/or Inconel alloy for use in the present disclosure includes from about 58% to about 63% nickel and/or from about 21% to about 25% chromium. In certain embodiments, the nickel-based and/or Inconel alloy can further include iron, aluminum, carbon, manganese, sulfur, silicon, copper or combinations thereof. Typically, production of syngas at an industrial level is carried out using metal reactors that have to be stable at the reaction temperatures of 680° C. and above. However, as described herein, the use of an Inconel alloy, e.g., Inconel-601, in the methods of the disclosed subject matter allows the hydrogenation of carbon dioxide to be performed at the above-mentioned temperatures without deformation or a decrease in mechanical strength.

In certain embodiments, the methods of the present disclosure can be performed within an reactor, disclosed herein, e.g., an Inconel-601 reactor, during long operational periods with minimal increases in the rate of methane formation and/or coke formation within the reactor as compared to a reactor that is not made from the Inconel alloy. For example, and not by way of limitation, the length of the long operational period can be greater than about 4 months, greater than about 5 months, greater than about 6 months, greater than about 7 months or greater than about 8 months.

In certain embodiments, the reactor for use in the present disclosure can include components and accessories including, but not limited to, one or more feed lines, gas exhaust lines, cyclones, product discharge lines, reaction zones and heating elements. The reactor can also include one or more measurement accessories. The one or more measurement accessories can be any suitable measurement accessory known to one of ordinary skill in the art including, but not limited to, pH meters, pressure indicators, pressure transmitters, thermowells, temperature-indicating controllers, gas detectors, analyzers and viscometers. The components and accessories can coupled to the reactor at various locations on the reactor.

“Coupled” as used herein refers to the connection of a system component to another system component by any means known in the art. The type of coupling used to connect two or more system components can depend on the scale and operability of the system. For example, and not by way of limitation, coupling of two or more components of a system can include one or more joints, valves, fittings, couplings, transfer lines or sealing elements. Non-limiting examples of joints include threaded joints, soldered joints, welded joints, compression joints and mechanical joints. Non-limiting examples of fittings include coupling fittings, reducing coupling fittings, union fittings, tee fittings, cross fittings and flange fittings. Non-limiting examples of valves include gate valves, globe valves, ball valves, butterfly valves and check valves.

The catalysts to be used in the methods of the disclosed subject matter can be any catalyst suitable for hydrogenation of carbon dioxide known to one of ordinary skill in the art. For example, catalyst compositions suitable for catalyzing hydrogenation of carbon dioxide include metal oxides, carbides, hydroxides or combinations thereof. Non-limiting examples of suitable metals include oxides of chromium (Cr), copper (Cu), manganese (Mn), potassium (K), palladium (Pd), cobalt (Co), cerium (Ce), tungsten (W), platinum (Pt), sodium (Na) and cesium (Cs).

The catalysts compositions for use in the methods of the presently disclosed subject matter can further include an inert carrier or support material. Suitable supports can be any support materials, which exhibit good stability at the reaction conditions of the disclosed methods, and are known by one of ordinary skill in the art. In certain embodiments, the support material can include aluminium oxide (alumina), magnesia, silica, titania, zirconia and mixtures or combinations thereof. In certain embodiments, the support material is alumina. In certain embodiments, the catalyst compositions of the present disclosure further include one or more promoters. Non-limiting examples of suitable promoters include lanthanides, alkaline earth metals and combinations thereof.

U.S. Pat. Nos. 8,551,434 and 8,288,446, incorporated herein by reference in their entireties, disclose catalysts that can be used in the methods of the present disclosure. Additional non-limiting examples of catalyst compositions include Cr₂O₃, Cr/Al₂O₃, Cr/SiO₂, Cu—Mn/Al₂O₃ and Cr/MgO.

The catalyst used in the present disclosure can be prepared by any catalyst synthesis process well known in the art. See, for example, U.S. Pat. Nos. 6,299,995, 6,293,979 and 8,288,446, each of which is incorporated herein by reference in its entirety. Additional examples include, but are not limited to, spray drying, precipitation, impregnation, incipient wetness, ion exchange, fluid bed coating, physical or chemical vapor deposition.

The following examples are merely illustrative of the presently disclosed subject matter and should not be considered as a limitation in any way.

### Example 1

### Hydrogenation of Carbon Dioxide to Form Syngas in an Inconel-601 Reactor

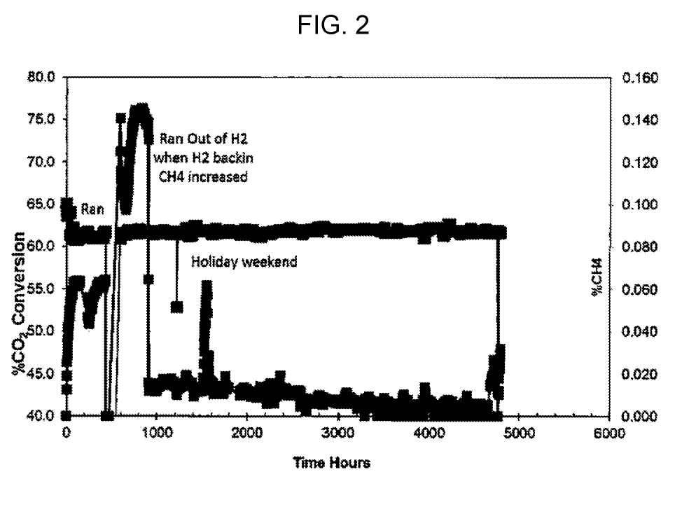

Hydrogenation of CO₂ by hydrogen to form a syngas composition was performed in an Inconel-601 metal reactor at isothermal conditions. A gaseous feedstream containing carbon dioxide and hydrogen was contacted with a catalyst within the reactor at a temperature of 650° C. Industrial Cr/Al₂O₃-based CATOFIN catalyst was used as the catalyst for CO₂ hydrogenation. Catalyst loading was 562.8 gram (554 ml), and the flow rate (i.e., feed rate) of the gases was as follows: H₂: 2550.6 cc/min, CO₂: 822.8 cc/min. The amount of methane formed during the hydrogenation of CO₂ to syngas was monitored over long-term operation of the reactor (FIG. 2). Methane content in the syngas product stream, which further contained CO, CO₂ and H₂, was monitored through gas chromatography (GC) analysis. Coke formation was then determined based on the amount of methane that was formed as represented by Reaction Formula 5 below, where Me refers to the metal of the reactor:

CO₂+H₂→CO+H₂ [Reaction Formula 3]

CO+Me→C-Me+CO₂ [Reaction Formula 4]

C-Me+2H₂→CH₄ [Reaction Formula 5]

As shown in FIG. 2, formation of methane in the Inconel-601 reactor is very small (about 0.006%) and no increase in methane formation was observed within the reactor over an extended operation time. These data confirm that the use of an Inconel-601 reactor at a temperature of 650° C. minimizes methane formation and coke accumulation. Furthermore, the performance of this reaction at a low temperature leads to the reduction of the energy that would have normally been used to preheat the feed for the higher endothermic reaction temperature.

### Example 2

### Hydrogenation of Carbon Dioxide to Form Syngas in a Steel Reactor

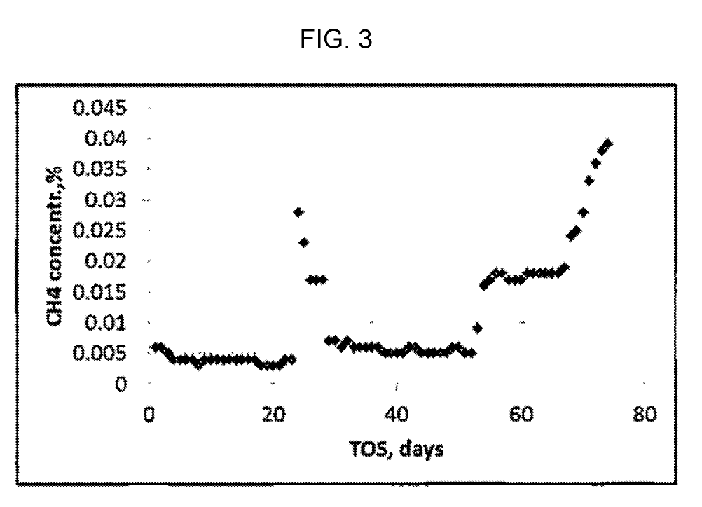

This Example analyzes the hydrogenation of CO₂ in a small scale 316 stainless steel metal reactor, using the same reaction conditions as in Example 1, excluding the differences in reactor material, size and catalyst loading. Catalyst loading was 7.3 g, and the flow rates of the gases were as follows: CO₂: 9.6 cc/min, and H₂: 38.4 cc/min. The amount of methane formed within the 316 stainless steel metal reactor is shown in FIG. 3.

Comparison of the results obtained with the Inconel-601 reactor in Example I with this Example shows that in the 316 stainless steel metal reactor the rate of methane formation, which corresponds to the amount of coke, is greater and increased very sharply over time (FIG. 3). In contrast, the rate of methane formation in the Inconel-601 metal reactor is very low and is reduced over time (FIG. 1), indicating that use of the Inconel-601 reactor for the hydrogenation of CO₂ results in the reduction and/or minimization of coke formation and can provide a more economical method for CO₂ hydrogenation. In addition, the amount of coke that accumulated in the 316 stainless steel metal reactor within 70 days was about 4-6% relative to the catalyst loading, while in the case of the Inconel metal reactor 601, the amount of coke was less than 3% during operation of the reactor over a 6 month operation period.

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the compositions and methods of the disclosed subject matter without departing from the spirit or scope of the disclosed subject matter. Thus, it is intended that the disclosed subject matter include modifications and variations that are within the scope of the appended claims and their equivalents. Various patents and patent applications are cited herein, the contents of which are hereby incorporated by reference herein in their entireties.

1. A method for producing syngas, comprising contacting a feedstream comprising hydrogen and carbon dioxide with a catalyst at a temperature of about 650° C. or lower in an Inconel alloy reactor to produce a syngas mixture comprising hydrogen and carbon monoxide.

2. The method of claim 1, wherein the Inconel alloy comprises Inconel-601.

3. The method of claim 1, wherein the Inconel alloy comprises from about 58% to about 63% nickel and from about 21% to about 25% chromium.

4. A method for producing syngas, comprising:
a) introducing a feedstream comprising hydrogen and carbon dioxide into an Inconel alloy reactor;
b) contacting the feedstream with a catalyst at a temperature lower than about 700° C. to generate a syngas mixture comprising carbon monoxide and hydrogen; and
c) removing a substantial portion of the syngas mixture from the reactor.

5. The method of claim 4, wherein the Inconel alloy comprises Inconel-601.

6. A method for producing syngas, comprising contacting a gaseous hydrocarbon feedstream comprising carbon dioxide and hydrogen with a catalyst in a nickel-based metal reactor at a temperature of about 650° C. to generate a syngas mixture.

7. The method of claim 6, wherein the nickel-based metal comprises from about 58% to about 63% nickel and from about 21% to about 25% chromium.

8. The method of claim 6, wherein the nickel-based metal comprises an Inconel-alloy.

9. The method of claim 6, wherein the nickel-based metal comprises Inconel-601.

10. The method of claim 6, wherein the metal reactor is an Inconel-601 metal reactor, and wherein the temperature is from about 650° C. to about 750° C., and wherein coke or methane formation is reduced during long-term operation of the reactor as compared to a reactor that is not fabricated with Inconel-601.

11. The method of claim 10, wherein the syngas comprises hydrogen and carbon monoxide.

12. The method of claim 10, wherein the catalyst comprises Cr/Al₂O₃.

13. The method of claim 10, wherein the catalyst comprises a CATOFIN® catalyst.

14. The method of claim 10, wherein the catalyst comprises about 15% to about 16% of chromium on an Al₂O₃ scaffold.

15. The method of claim 12, wherein the syngas comprises hydrogen and carbon monoxide.

16. The method of claim 13, wherein the syngas comprises hydrogen and carbon monoxide.

17. The method of claim 14, wherein the syngas comprises hydrogen and carbon monoxide.

18. The method of claim 6, wherein the temperature is 650° C.

19. The method of claim 10, wherein the temperature is 650° C.

20. The method of claim 10, wherein the temperature is 750° C.
